(19) United States
(12) Patent Application Publication
(10) Pub. No.: US 2026/0302861 A1
(43) Pub. Date: Oct. 1, 2026

(54) METHOD OF MANUFACTURING STATOR, AND STATOR OF ROTATING ELECTRIC MACHINE

(71) Applicant: HONDA MOTOR CO., LTD., Tokyo (JP)

(72) Inventors: Yuki Nakanishi, Wako-shi (JP); Yuki Abe, Wako-shi (JP)

(21) Appl. No.: 19/575,310

(22) Filed: Mar. 23, 2026

(30) Foreign Application Priority Data
Mar. 26, 2025 (JP) 2025-050952

(51) Int. Cl. H02K 3/24; H02K 3/34; H02K 15/122

(52) U.S. Cl. CPC H02K 3/24; H02K 3/34; H02K 15/122

(57) ABSTRACT

A method of manufacturing a stator includes an insertion step of inserting a wire and a solid material into a slot formed in a stator core in a manner so that the solid material is positioned adjacent to the wire in a radial direction of the stator core; a fixing step of fixing the wire in the slot after the insertion step; and a removal step of removing the solid material from the slot after the fixing step.

### CROSS-REFERENCE TO RELATED APPLICATIONS

This application is based upon and claims the benefit of priority from Japanese Patent Application No. 2025-050952 filed on Mar. 26, 2025, the contents of which are incorporated herein by reference.

### BACKGROUND OF THE INVENTION

### FIELD OF THE INVENTION

The present disclosure relates to a method of manufacturing a stator and a stator of a rotating electric machine.

### DESCRIPTION OF THE RELATED ART

In order to cool a coil in a stator of a rotating electric machine, WO 2023/064379 A1 discloses a method of forming flow channels for cooling fluids in a slot by molding.

### SUMMARY OF THE INVENTION

In the above-described conventional technique, it is necessary to perform processing for forming protrusions for separating the coils from each other after molding. Therefore, it is desired that the coolant flow path can be easily formed.

The present disclosure has the object of satisfying the aforementioned need.

A first aspect of the present disclosure is a method of manufacturing a stator of a rotating electric machine, the method including: an insertion step of inserting a wire and a solid material into a slot formed in a stator core in a manner so that the solid material is positioned adjacent to the wire in a radial direction of the stator core; a fixing step of fixing the wire in the slot after the insertion step; and a removal step of removing the solid material from the slot after the fixing step.

A second aspect of the present disclosure is a stator of a rotating electric machine, the stator including: a stator core including a slot formed therein; a wire inserted into the slot; and a fixing resin made of a thermosetting resin and which is disposed, in the slot, on each of both sides of the wire in a circumferential direction of the stator core, the fixing resin fixing the wire to the slot, wherein a coolant flow path is formed at a position adjacent to the wire in a radial direction of the stator, and in the circumferential direction, a width of the coolant flow path is larger than a width of the wire.

According to the present disclosure, by removing the solid material from the slot after inserting the wire and the solid material into the slot, the coolant flow path can be formed at the position formerly occupied by the solid material. Accordingly, the coolant flow path can be easily formed, and the wire can be effectively cooled.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic view of a stator;

FIG. 2A is a first view for explaining a method of manufacturing a stator;

FIG. 2B is a second view illustrating the method of manufacturing the stator;

FIG. 2C is a third view for explaining the method of manufacturing the stator;

FIG. 3A is a perspective view showing a first coating pattern of a hot-melt material;

FIG. 3B is a perspective view showing a second coating pattern of the hot-melt material;

FIG. 4 is a flowchart of a method of manufacturing a stator;

FIG. 5 is a flowchart illustrating another procedure of the method of manufacturing the stator;

FIG. 6A is a first view for explaining a method of manufacturing a stator according to a modification;

FIG. 6B is a second view for explaining the method of manufacturing the stator according to the modification; and

FIG. 6C is a third view for explaining the method of manufacturing the stator according to the modification.

### DETAILED DESCRIPTION OF THE INVENTION

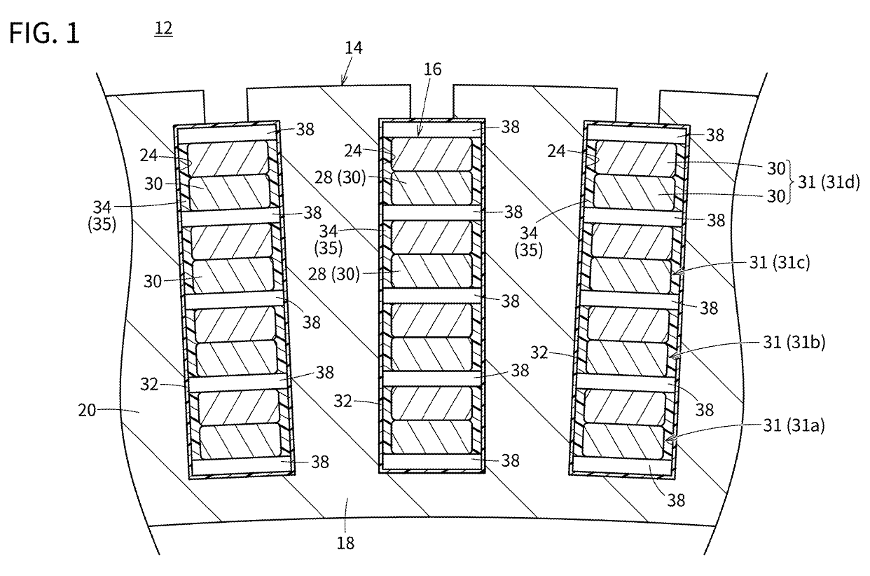

As shown in FIG. 1, a stator 12 of a rotating electric machine includes a stator core 14 and an electromagnetic coil portion 16. In the present embodiment, the stator 12 is a stator applied to an outer rotor type rotating electric machine. The technique of the present disclosure is also applicable to a stator applied to an inner rotor type rotating electric machine. In the following description, the circumferential direction, the axial direction, and the radial direction of the stator core 14 may be simply referred to as "circumferential direction", "axial direction", and "radial direction", respectively.

The stator core 14 includes a circular ring portion 18, a plurality of teeth 20, and a plurality of slots 24. The circular ring portion 18 is a back yoke. The plurality of teeth 20 are provided at intervals in the circumferential direction. The plurality of teeth 20 protrude radially outward from the circular ring portion 18. The plurality of slots 24 are formed between the plurality of teeth 20. Therefore, the plurality of slots 24 are provided at intervals in the circumferential direction.

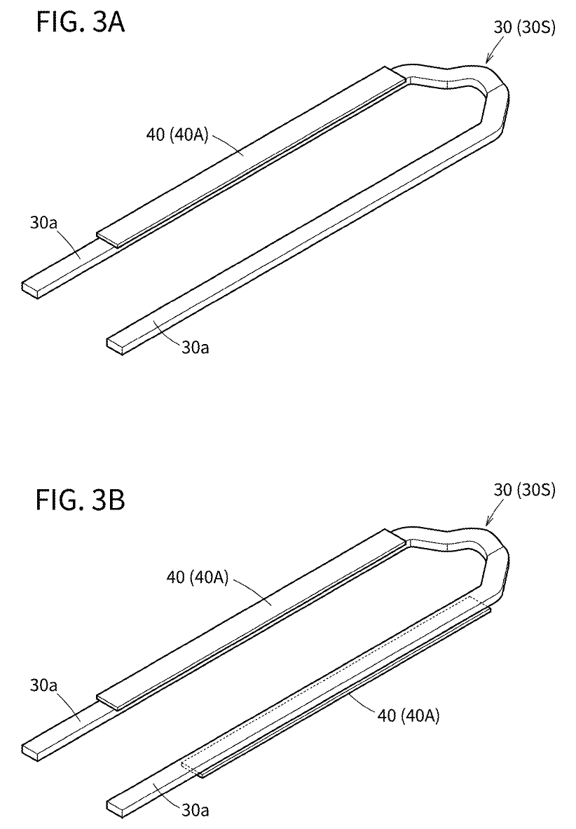

The electromagnetic coil portion 16 is constituted by a plurality of wires 28. The electromagnetic coil portion 16 is formed by inserting substantially U-shaped segment coils 30S (see FIG. 3A) into the slots 24 and then joining end portions (coil ends) protruding from the slots 24. Hereinafter, the wire 28 is also referred to as a "coil 30". A plurality of the wires 28 are inserted into each slot 24 in a state of being arranged in the radial direction. In the illustrated example, eight wires 28 are inserted into each slot 24. Although not shown in detail, the wire 28 includes a conductor portion as a base material, and an insulating coating. The surface of the conductor portion is covered with the insulating coating.

In each slot 24, an insulating film 32 is disposed between the tooth 20 and the plurality of wires 28. The insulating film 32 is disposed so as to surround the plurality of wires 28 inserted into the slot 24. A fixing resin 34 is disposed between the wires 28 and the insulating film 32. The fixing resin 34 is formed by thermally hardening a thermosetting resin 35. The fixing resin 34 fixes the wires 28 in the slot 24.

In the present embodiment, two coils 30 adjacent to each other in the radial direction constitute one coil set 31, and four coil sets 31 are disposed at intervals in the radial direction. The fixing resin 34 is disposed on each of both sides of each coil set 31 in the circumferential direction (i.e., both sides in the width direction). A plurality of coolant (cooling liquid) flow paths 38 are formed in the slot 24. Each coolant flow path 38 is formed at a position adjacent to the wire 28 in the radial direction. The coolant flow path 38 is a flow path for flowing a coolant. The coolant is, for example, water, oil, or the like. The width of the coolant flow path 38 in the circumferential direction of the stator 12 is larger than the width of the wire 28. Therefore, both end portions of the coolant flow path 38 in the width direction are located at positions adjacent to the fixing resin 34 in the radial direction of the stator 12.

The coolant flow path 38 is formed between the coil sets 31 adjacent to each other in the radial direction. Further, the coolant flow path 38 is formed on the radially inner side of the coil set 31a which is positioned on the radially innermost side, and the coolant flow path 38 is formed on the radially outer side of the coil set 31d which is positioned on the radially outermost side. The coolant flow paths 38 penetrate the stator core 14 in the axial direction and are open to end surfaces on both sides of the stator core 14 in the axial direction. The coolant flows through the coolant flow paths 38, and thus the coils 30 can be effectively cooled.

Next, a method of manufacturing the stator 12 will be described.

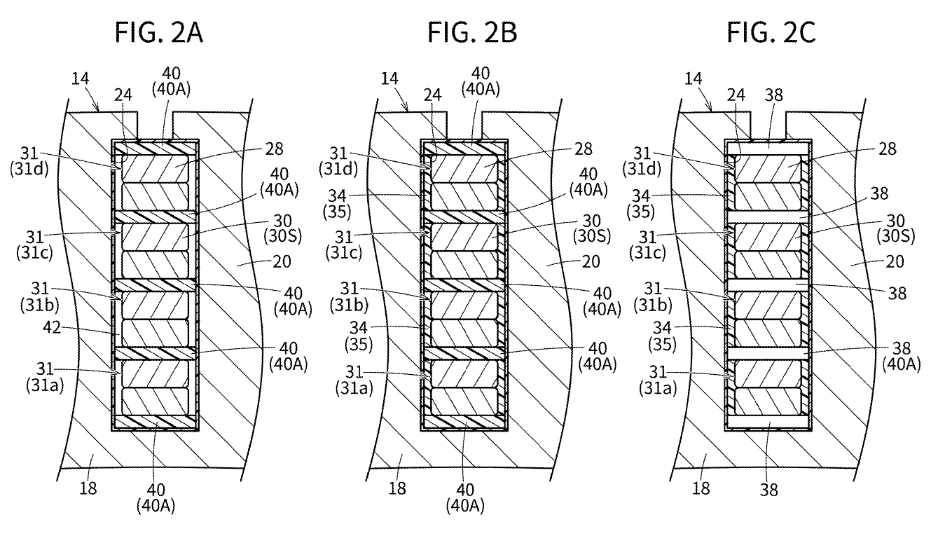

First, an outline of a method for manufacturing the stator 12 will be described with reference to FIGS. 2A to 2C. The method of manufacturing the stator 12 includes an insertion step, a fixing step, and a removal step.

As shown in FIG. 2A, in the insertion step, the wires 28 (segment coils 30S) and solid material 40 are inserted into the slot 24 formed in the stator core 14 in a manner so that the solid material 40 is positioned adjacent to the wires 28 in the radial direction of the stator core 14. The solid material 40 is a hot-melt material 40A (resin). The solid material 40 is a material that can prevent direct contact between the wire 28 adjacent to one side of the solid material 40 and the other wire 28 adjacent to the other side of the solid material 40, even at the hardening temperature of the thermosetting resin 35 (see FIG. 2B) described later. The solid material 40 is a material that does not deform even at the hardening temperature of the thermosetting resin 35. The solid material 40 has a softening point equal to or higher than the hardening temperature of the thermosetting resin 35 (FIG. 2B). The plurality of coils 30 are arranged in the slots 24 such that gaps 42 are formed on both sides of each coil set 31 in the circumferential direction.

The fixing step is performed after the insertion step. As shown in FIG. 2B, in the fixing step, the wires 28 are fixed in the slots 24. Specifically, in the fixing step, the thermosetting resin 35 is inserted into the slots 24, and then the thermosetting resin 35 is heated to fix the wires 28 in the slots 24. The thermosetting resin 35 is, for example, a varnish. The thermosetting resin 35 is impregnated into the gaps 42 that have been formed, in the insertion step, on both sides of each coil set 31 in the circumferential direction. Thereafter, the thermosetting resin 35 is heated and thermally hardened, thereby fixing the coil sets 31.

The removal step is performed after the fixing step. In the removal step, the solid material 40 is removed from the slots 24. Specifically, in the removal step, the solid material 40 is heated to a temperature equal to or higher than the softening point after the thermosetting resin 35 has been hardened, so that the solid material 40 is brought into a flowable state, and the solid material 40 is then removed from the slots 24. As a result, as shown in FIG. 2C, the coolant flow paths 38 are formed at positions adjacent to the wires 28 in the slots 24. The solid material 40 can be removed by its own weight or pressure at a temperature equal to or higher than the softening point of the solid material 40, but the temperature is preferably equal to or higher than the melting point of the solid material 40. If the temperature is equal to or higher than the melting point, the melted solid material 40 can be easily removed from the slots 24 by means of air blowing or the like.

Next, the method of manufacturing the stator 12 will be described in more detail with reference to FIGS. 3A to 5.

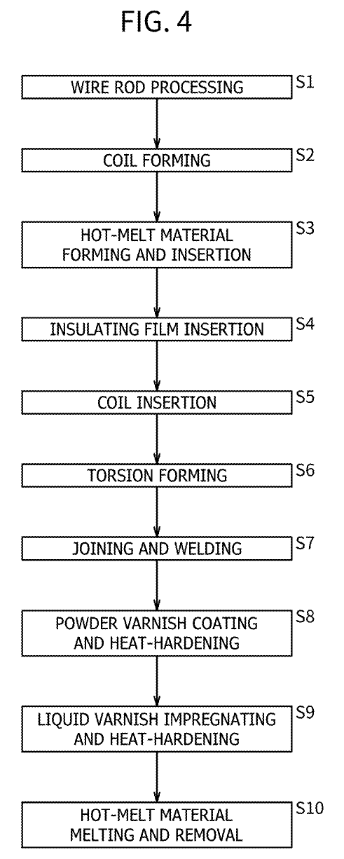

In step S1 of FIG. 4, a wire rod is processed. The wire rod is a raw material for the coil 30 (FIG. 3A). In step S2, as shown in FIG. 3A, the coil 30 (segment coil 30S) is formed into a substantially U-shape having a pair of leg portions 30a. In step S3, as shown in FIGS. 3A and 3B, the hot-melt material 40A is formed on the surface of the coil 30 (the leg portion 30a). The hot-melt material 40A extends along the leg portion 30a and is slightly wider than the leg portion 30a. In the segment coil 30S, the connecting portion that connects the pair of leg portions 30a to each other, and the distal end portions of the pair of leg portions 30a are portions that protrude from the slot 24, and therefore, the hot-melt material 40A is not formed on the portions. The softening point of the hot-melt material 40A needs to be higher than the heating temperature used for heating and thermally hardening powder varnish in step S8, which will be described later. The hot-melt material 40A has a softening point of, for example, 200° C or higher.

In this case, the coating pattern of the hot-melt material 40A on the coil 30 includes a first coating pattern shown in FIG. 3A and a second coating pattern shown in FIG. 3B. In the first coating pattern shown in FIG. 3A, the hot-melt material 40A is formed on the surface of one leg portion 30a of the coil 30 (i.e., the surface on one side in the thickness direction). In the second coating pattern shown in FIG. 3B, the hot-melt material 40A is formed on each of the surface of one leg portion 30a of the coil 30 (the surface on one side in the thickness direction of the coil 30) and the surface of the other leg portion 30a (the surface on the other side in the thickness direction of the coil 30). Instead of coating the coil 30 with the hot-melt material 40A, the hot-melt material 40A formed into a linear shape (thin strip shape) may be inserted between the plurality of coils 30. In step S4 of FIG. 4, the insulating film 32 is inserted into the slot 24.

Step S5 in FIG. 4 corresponds to the insertion step shown in FIG. 2A. In step S5, the plurality of coils 30 coated with the hot-melt material 40A (or the plurality of coils 30 into which the hot-melt material 40A is inserted) are inserted into the respective slots 24 of the stator core 14. In this case, in FIG. 2A, for example, the coil 30 of the second coating pattern (FIG. 3B) is used for the coil set 31a disposed on the radially innermost side. For the other coil sets 31b to 31d, for example, the coils 30 of the first coating pattern (FIG. 3A) are used.

As the coil 30 is inserted into the stator core 14, the coil end protrudes from the end surface (slot 24) of the stator core 14. In step S6, the coil ends protruding from the slots 24 are subjected to torsion forming. In the torsion forming, the coil ends of the plurality of coils 30 are torsionally bent in the circumferential direction of the stator core 14. At step S7, the torsionally bent coil ends are joined together by an appropriate means such as TIG welding.

In step S8, the powder varnish is coated to the joint portions of the coil ends, and the powder varnish is heated and hardened. In this case, the heating temperature is a temperature at which the hot-melt material 40A is neither softened nor melted. That is, the temperature of heating the powder varnish is equal to or lower than the softening point of the hot-melt material 40A. Therefore, when the softening point of the hot-melt material 40A is, for example, 200° C or higher, the heating temperature is, for example, 170° C to 190° C.

Step S9 corresponds to the fixing step shown in FIG. 2B. In step S9, liquid varnish, which is the thermosetting resin 35, is impregnated into the gaps 42 (FIG. 2A) in the slot 24. Next, the liquid varnish impregnated in the gaps 42 is heated and thermally hardened. In this case, the heating temperature for the liquid varnish is equal to or lower than the softening point of the hot-melt material 40A (for example, 100° C to 130° C). Therefore, the thermal hardening of the liquid varnish does not cause softening or melting of the hot-melt material 40A. The liquid varnish is thermally hardened to fix the wires 28 in the slot 24.

Step S10 corresponds to the removal step shown in FIG. 2C. In step S10, the hot-melt material 40A is heated and melt, and then removed from the slot 24. As a method of removing the hot-melt material 40A from the slot 24, discharge by its own weight, pushing out by air blow, vacuum evacuation, or the like can be adopted. The heating temperature for the hot-melt material 40A is higher than the heating temperature for the powder varnish, but is a temperature at which the varnish that has hardened in steps S8 and S9 does not melt.

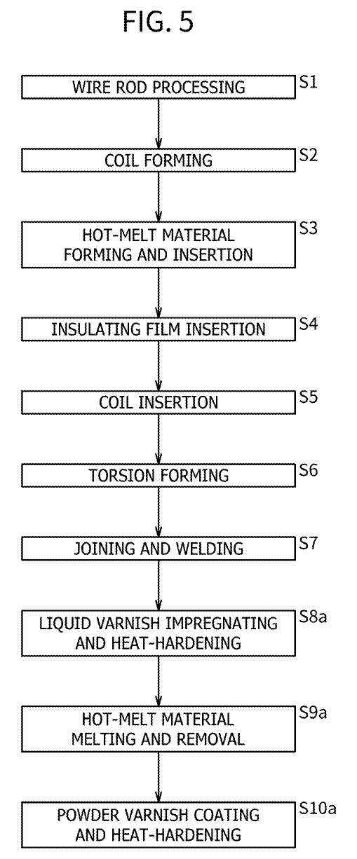

The method of manufacturing the stator 12 may be performed in the procedure shown in FIG. 5. In FIG. 5, steps S1 to S7 are the same as those in FIG. 4. However, the softening point of the hot-melt material 40A used in step S3 of FIG. 5 only needs to be equal to or higher than the heating temperature for the liquid varnish used in step S8a. Therefore, the softening point of the hot-melt material 40A may be lower than the heating temperature for thermally hardening the powder varnish used in step S10a.

Step S8a is the same as step S9 of FIG. 4, in which the liquid varnish is impregnated into the gaps 42 (FIG. 2A) in the slot 24 and is thermally hardened. The thermal hardening of the liquid varnish does not cause softening or melting of the hot-melt material 40A. In step S9a, the hot-melt material 40A is heated and melt, and then removed from the slot 24. In this case, the softening point of the hot-melt material 40A only needs to be higher than the heating temperature for thermally hardening the liquid varnish, and may be lower than the heating temperature for thermally hardening the powder varnish in step S10a. Accordingly, when the heating temperature for thermally hardening the liquid varnish is, for example, about 120° C, the hot-melt material 40A used in step S3 in FIG. 5 only needs to have a softening point of, for example, 125° C to 150° C. That is, in the manufacturing method according to the modification example of FIG. 5, the requirement for the softening point of the hot-melt material 40A can be relaxed, thereby allowing the use of the hot-melt material 40A having a lower softening point, as compared to the manufacturing method of FIG. 4.

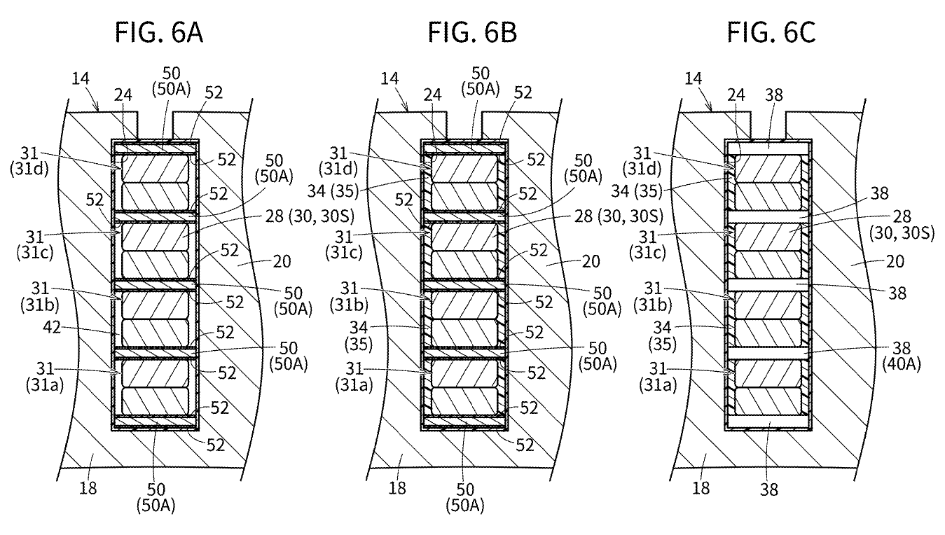

In the above-described embodiment, the hot-melt material 40A is used as the solid material 40, but a solid material 50 having a melting point of 500° C or higher may be used instead of the hot-melt material 40A, as shown in FIG. 6A. The solid material 50 is, for example, a metal member 50A having a plate shape. The metal member 50A is made of, for example, stainless steel (SUS304 or the like). A lubricity improving member 52 is formed on the surfaces of the metal member 50A. The lubricity improving member 52 is, for example, PTFE-containing electroless nickel plating. The lubricity improving member 52 may be provided on the surfaces of the metal member 50A by plating, for example. The lubricity improving member 52 is coated onto both surfaces of the metal member 50A in the thickness direction.

As shown in FIG. 6A, in the insertion step, the wires 28 and the solid material 50 (the metal members 50A) are inserted into the slot 24 formed in the stator core 14 in a manner so that the metal members 50A are positioned adjacent to the wires 28 in the radial direction of the stator core 14. In this case, a laminated body in which the plurality of metal members 50A and the plurality of coil sets 31 are alternately stacked is inserted into the slot 24.

As shown in FIG. 6B, in the fixing step, after inserting the thermosetting resin 35 into the slot 24, the thermosetting resin 35 is heated to fix the wires 28 in the slot 24. This step is the same as the step shown in FIG. 2B. In the removal step, the metal members 50A are removed from the slot 24 after the thermosetting resin 35 has been hardened. To be specific, in the removal step, the metal members 50A are pulled out from the slot 24, i.e., from the state shown in FIG. 6B. In this case, since the lubricity improving members 52 are formed on the surfaces of the metal members 50A, damage to the metal member 50A caused by pulling out is avoided. By pulling the metal members 50A out of the slot 24, the coolant flow paths 38 are formed at positions adjacent to the wires 28, as shown in FIG. 6C.

In the manufacturing method shown in FIGS. 6A to 6C, a material having a melting point of 500° C or higher is used as the solid material 50. When the melting point is 500° C or higher, the shape at the initial setup can be maintained without deformation due to creep or the like during the hardening of the thermosetting resin 35. Thus, it is possible to stably form the coolant flow paths 38.

In addition, the lubricity improving member 52 is formed on the surface of the solid material 50. This makes it easier to pull out the solid material 50 and prevents the solid material 50 from being damaged, thereby enabling the solid material 50 to be repeatedly used.

The following Supplementary Notes are further disclosed in relation to the above embodiment.

### Supplementary Note 1

The method of manufacturing the stator (12) is the method of manufacturing the stator of the rotating electric machine, the method including: the insertion step of inserting the wire (28) and the solid material (40) into the slot (24) formed in the stator core (14) such that the solid material is positioned adjacent to the wire in a radial direction of the stator core; the fixing step of fixing the wire in the slot after the insertion step; and the removal step of removing the solid material from the slot after the fixing step. According to the above manufacturing method, the coolant flow path can be formed at a position formerly occupied by the solid material, by removing the solid material from the slot after inserting the wire and the solid material into the slot. Accordingly, the coolant flow path can be easily formed, and the wire can be effectively cooled.

### Supplementary Note 2

In the method of manufacturing the stator according to Supplementary Note 1, in the fixing step, the wire may be fixed in the slot by inserting the thermosetting resin (35) into the slot and thereafter heating the thermosetting resin. This makes it possible for the wire to be well fixed in the slot.

### Supplementary Note 3

In the method of manufacturing the stator according to Supplementary Note 2, the solid material may be a material that serves to prevent direct contact between the wire adjacent to one side of the solid material and another wire adjacent to the other side of the solid material, even at the hardening temperature of the thermosetting resin.

### Supplementary Note 4

In the method of manufacturing the stator according to Supplementary Note 3, the solid material may be a material that does not deform even at the hardening temperature of the thermosetting resin. If a material that melts or deforms due to an external force or its own weight at a temperature lower than the hardening temperature of the thermosetting resin is used, the wire may be disadvantageously displaced due to melting or deformation during thermosetting. In contrast, the use of the above-mentioned solid material prevents the displacement of the wire, and makes it possible to form the coolant flow path for cooling the wire.

### Supplementary Note 5

In the method of manufacturing the stator according to Supplementary Note 2, the solid material may have a softening point equal to or higher than the hardening temperature of the thermosetting resin, and in the removal step, the solid material may be removed from the slot by raising the temperature of the solid material to the softening point or higher after the thermosetting resin has been hardened. This allows for efficient removal of the solid material from the slot, thereby reducing the manufacturing load.

### Supplementary Note 6

In the method of manufacturing the stator according to Supplementary Note 2, the solid material (50) may be a material having the melting point of 500° C or higher, and in the removal step, the solid material may be pulled out from the slot after the thermosetting resin has been hardened. With the above configuration, when the melting point is 500° C or higher, the shape at the initial setup can be maintained without deformation due to creep or the like during the hardening of the thermosetting resin. Thus, it is possible to stably form the coolant flow paths.

### Supplementary Note 7

In the method of manufacturing the stator according to Supplementary Note 2, the lubricity improving member (52) may be formed on the surface of the solid material. This makes it easier to pull out the solid material and prevents the solid material from being damaged, thereby enabling the solid material to be repeatedly used.

### Supplementary Note 8

The stator of the rotating electric machine according to the present disclosure includes: the stator core including the slot formed therein; the wire inserted into the slot; and the fixing resin (34) made of a thermosetting resin and which is disposed, in the slot, on each of both sides of the wire in the circumferential direction of the stator core, the fixing resin fixing the wire to the slot, wherein the coolant flow path (38) is formed at a position adjacent to the wire in the radial direction of the stator, and in the circumferential direction, the width of the coolant flow path is larger than the width of the wire.

Although the present disclosure has been described in detail, the present disclosure is not limited to the above-described embodiments. In these embodiments, various additions, replacement, changing, partial deletion, and the like can be made without departing from the essence and gist of the present disclosure or without departing from the essence and gist of the present disclosure derived from the contents described in the claims and equivalents thereof. Further, the embodiments can also be implemented together in combination. For example, in the above-described embodiments, the order of each of the operations and the order of each of the processes are illustrated as examples, and the present invention is not necessarily limited to these features. The same applies also in the case that numerical values or mathematical equations are used in the description of the aforementioned embodiments.

1. A method of manufacturing a stator of a rotating electric machine, the method comprising:
inserting a wire and a solid material into a slot formed in a stator core in a manner so that the solid material is positioned adjacent to the wire in a radial direction of the stator core;
fixing the wire in the slot after the inserting of the wire and the solid material into the slot; and
removing the solid material from the slot after the fixing of the wire in the slot.

2. The method of manufacturing the stator according to claim 1, wherein
in the fixing of the wire in the slot, the wire is fixed in the slot by inserting a thermosetting resin into the slot and thereafter heating the thermosetting resin.

3. The method of manufacturing the stator according to claim 2, wherein
the solid material is a material that serves to prevent direct contact between the wire adjacent to one side of the solid material and another wire adjacent to another side of the solid material, even at a hardening temperature of the thermosetting resin.

4. The method of manufacturing the stator according to claim 3, wherein
the solid material is a material that does not deform even at the hardening temperature of the thermosetting resin.

5. The method of manufacturing the stator according to claim 2, wherein
the solid material has a softening point equal to or higher than a hardening temperature of the thermosetting resin, and
in the removing of the solid material from the slot, the solid material is removed from the slot by raising a temperature of the solid material to the softening point or higher after the thermosetting resin has been hardened.

6. The method of manufacturing the stator according to claim 2, wherein
the solid material is a material having a melting point of 500°C or higher, and
in the removing of the solid material from the slot, the solid material is pulled out from the slot after the thermosetting resin has been hardened.

7. The method of manufacturing the stator according to claim 6, wherein
a lubricity improving member is formed on a surface of the solid material.

8. A stator of a rotating electric machine, the stator comprising:
a stator core including a slot formed therein;
a wire inserted into the slot; and
a fixing resin made of a thermosetting resin and which is disposed, in the slot, on each of both sides of the wire in a circumferential direction of the stator core, the fixing resin fixing the wire to the slot, wherein
a coolant flow path is formed at a position adjacent to the wire in a radial direction of the stator, and
in the circumferential direction, a width of the coolant flow path is larger than a width of the wire.
